(19) United States
(12) Patent Application Publication
(10) Pub. No.: US 2010/0017299 A1
(43) Pub. Date: Jan. 21, 2010

(54) METHODS, DEVICES, SYSTEMS, AND COMPUTER PROGRAM PRODUCTS FOR LOCATING ITEMS OFFERED BY VENDORS AT CUSTOMER PREFERRED PRICES

(75) Inventor: Akbar Pirani, Marietta, GA (US)

Correspondence Address: AT&T Legal Department - CC;Attn: Patent Docketing, Room 2A-207, One AT&T Way, Bedminster, NJ, 07921, US

(73) Assignee: AT&T DELAWARE INTELLECTUAL PROPERTY, INC., Wilmington, DE (US)

(21) Appl. No.: 12/125,340

(22) Filed: Jul. 18, 2008

(51) Int. Cl. G06Q 30/00

(52) U.S. Cl. 705/26

(57) ABSTRACT

Methods, devices, systems, and computer program products for locating items offered by vendors at customer preferred prices are provided. The methods comprise receiving customer preferences including a customer identifier associated with a preferred item identifier and a preferred maximum price identifier. Vendor information is received which includes a vendor identifier associated with an offered item identifier and an offered item price identifier. The customer preferences and vendor information are stored, wherein the stored customer preferences include one or more stored preferred item identifiers and the stored vendor information includes one or more stored offered item identifiers. The stored preferred item identifiers are compared with the stored offered item identifiers. If a preferred item identifier matches an offered item identifier, the offered item price identifier associated with the matching offered item identifier is retrieved, and the preferred maximum price identifier associated with the matching preferred item identifier is retrieved. If the offered item price identifier is less than or equal to the preferred maximum price identifier, a matching price record is generated.

### BACKGROUND

Exemplary embodiments relate generally to electronic commerce and, more particularly, to methods, devices, systems, and computer program products for locating goods and services offered by vendors at customer preferred prices.

At present, a multitude of vendors offer a vast selection of goods and services over the Internet. The cost of a desired good or service may vary substantially from one vendor to another, thereby providing an incentive for consumers to conduct Internet searches to locate a vendor selling the desired item at or below a customer's desired target price. These searches are laborious and time consuming. Accordingly, automated web portals such as Priceline.com have been developed to facilitate consumers in locating desired items at target prices. Such web portals typically allow prospective buyers of goods and services to communicate binding purchase offers to a plurality of potential sellers. These sellers examine buyer purchase offers in real time and, upon locating an acceptable offer, are allowed to bind the buyer to a contract based on the buyer's initial purchase offer.

If a predefined interval of time has elapsed and the buyer's purchase offer has not yet been accepted, the order automatically expires and can no longer be accepted by a seller. The buyer's purchase offer is not saved for future reference. Although useful in situations where a buyer wishes to irrevocably commit themselves to a purchase, such approaches are problematic for buyers who are conducting preliminary pricing research. Buyers may not wish to bind themselves to a price unless they are provided with an opportunity to research existing price data. Moreover, due to the fact that the prices of many items are in a constant state of flux and buyer purchase offers are not saved, submission of multiple offers may be required over the course of days or weeks for a buyer to locate a desired item at a target price.

In view of the aforementioned shortcomings, it would be desirable to formulate a fast, efficient, and convenient approach for locating goods and services offered by vendors at customer preferred prices.

### BRIEF SUMMARY

Exemplary embodiments relate to methods of locating items offered by vendors at customer preferred prices. The items may include goods, services, or a combination of goods and services. The methods comprise receiving customer preferences including a customer identifier associated with a preferred item identifier and a preferred maximum price identifier. Vendor information is received which includes a vendor identifier associated with an offered item identifier and an offered item price identifier. The customer preferences and vendor information are stored. The stored customer preferences include one or more stored preferred item identifiers, and the stored vendor information includes one or more stored offered item identifiers. The stored preferred item identifiers are compared with the stored offered item identifiers. If a preferred item identifier matches an offered item identifier, the offered item price identifier associated with the matching offered item identifier is retrieved, and the preferred maximum price identifier associated with the matching preferred item identifier is retrieved. If the offered item price identifier is less than or equal to the preferred maximum price identifier, a matching price record is generated.

Additional exemplary embodiments include computer program products comprising a storage medium readable by a processing circuit and storing instructions for execution by the processing circuit for facilitating methods of locating items offered by vendors at customer preferred prices. The items may include goods, services, or a combination of goods and services. The methods comprise receiving customer preferences including a customer identifier associated with a preferred item identifier and a preferred maximum price identifier. Vendor information is received which includes a vendor identifier associated with an offered item identifier and an offered item price identifier. The customer preferences and vendor information are stored. The stored customer preferences include one or more stored preferred item identifiers, and the stored vendor information includes one or more stored offered item identifiers. The stored preferred item identifiers are compared with the stored offered item identifiers. If a preferred item identifier matches an offered item identifier, the offered item price identifier associated with the matching offered item identifier is retrieved, and the preferred maximum price identifier associated with the matching preferred item identifier is retrieved. If the offered item price identifier is less than or equal to the preferred maximum price identifier, a matching price record is generated.

Additional exemplary embodiments include a device or a group of devices for locating items offered by vendors at customer preferred prices. The items may include goods, services, or a combination of goods and services. The device or group of devices includes an input mechanism for specifying customer preferences including a customer identifier, a preferred item identifier, and a preferred maximum price identifier. The device or group of devices also includes a communications mechanism, operatively coupled to the input mechanism, for transmitting the specified customer preferences to a communications network, and for receiving a matching price record from the communications network. The matching price record includes a vendor identifier associated with an offered item price identifier. The vendor identifier corresponds to a vendor offering the item for sale at an offered item price at or below a maximum price specified by the preferred maximum price identifier. The device or group of devices also includes an output mechanism, operatively coupled to the communications mechanism, for performing at least one of storing the matching price record in a computer-readable storage medium, electronically displaying information indicative of the vendor identifier and the offered item price identifier, outputting the matching price record to a data communications port, or generating a printout indicative of the vendor identifier and the offered item price identifier.

Additional exemplary embodiments include a system for locating items offered by vendors at customer preferred prices. The items may include goods, services, or a combination of goods and services. The system includes a receiving mechanism for receiving customer preferences and vendor information. Customer preferences include a customer identifier associated with a preferred item identifier and a preferred maximum price identifier. Vendor information includes a vendor identifier associated with an offered item identifier and an offered item price identifier. The system includes a computer readable storage mechanism for storing the customer preferences and vendor information. The stored customer preferences include one or more stored preferred item identifiers, and the stored vendor information includes one or more stored offered item identifiers. The system also includes a processing mechanism capable of comparing the stored customer preferences with the stored vendor information to determine whether or not a preferred item identifier matches an offered item identifier. If a match exists, the processing mechanism determines whether or not the offered item price identifier is less than or equal to the preferred maximum price identifier. If so, the processing mechanism generates an acquired matching price record.

Other systems, methods, and/or computer program products according to embodiments will be or become apparent to one with skill in the art upon review of the following drawings and detailed description. It is intended that all such additional systems, methods, and/or computer program products be included within this description, be within the scope of the exemplary embodiments, and be protected by the accompanying claims.

### BRIEF DESCRIPTION OF DRAWINGS

Referring now to the drawings wherein like elements are numbered alike in the several FIGURES:

FIG. 1 is a block diagram of an exemplary system that may be utilized for locating goods and services offered by vendors at customer preferred prices.

FIG. 2 is a data structure diagram showing an exemplary customer preferences table for use with the system of FIG. 1.

FIG. 3 is a data structure diagram showing an exemplary vendor information table for use with the system of FIG. 1.

FIG. 4 is a data structure diagram showing an exemplary acquired prices table for use with the system of FIG. 1.

FIGS. 5A-5D together comprise a flow diagram of an exemplary process for locating goods and services offered by vendors at customer preferred prices.

The detailed description explains the exemplary embodiments, together with advantages and features, by way of example with reference to the drawings.

### DETAILED DESCRIPTION OF EXEMPLARY EMBODIMENTS

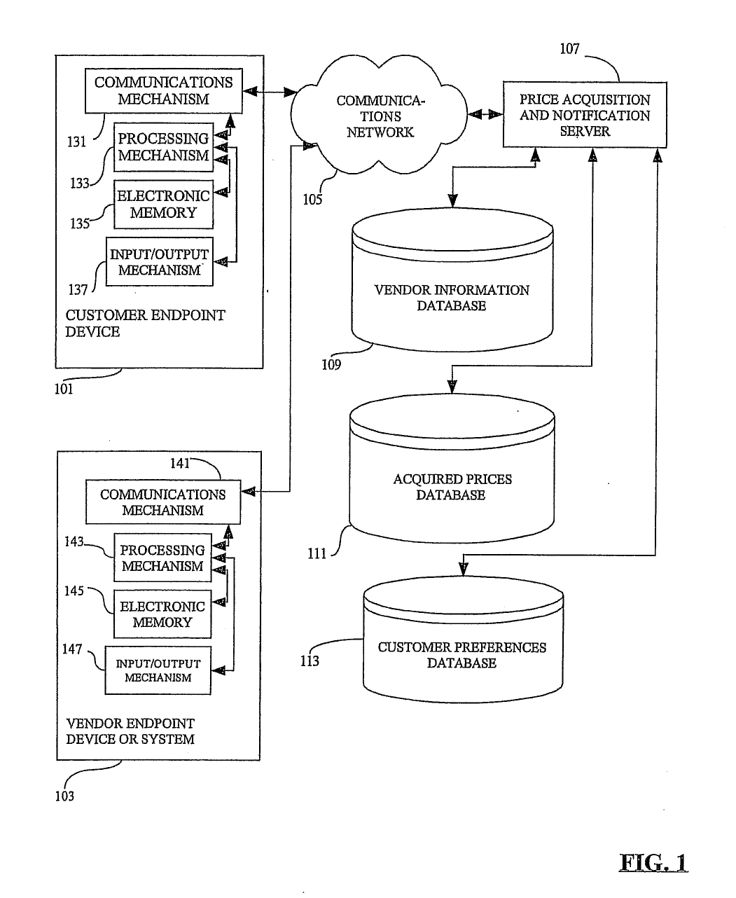

FIG. 1 is a block diagram of an exemplary system that may be utilized for locating goods and services offered by vendors at customer preferred prices. A communications network 105 is illustratively implemented using the Internet, a private intranet, a public switched telephone network (PSTN), a cable television network, or any of various combinations thereof Customer endpoint device 101 represents any device or group of devices that includes a processing mechanism 133 operatively coupled to an electronic memory 135, an input/output mechanism 137 operatively coupled to processing mechanism 133, and a communications mechanism 131 capable of initiating electronic communication over communications network 105. Processing mechanism 133 is capable of storing data in electronic memory 135, and is also capable of retrieving data from electronic memory 135. The specific architecture employed for customer endpoint device 101 is illustrative in nature, it being clearly understood that other architectures could be employed instead of, or in addition to, the architecture shown in FIG. 1.

Electronic memory 135 is capable of storing one or more matching price records each setting forth a vendor identifier associated with an item identifier and an offered item price identifier. An item identifier may include alphabetic or alphanumeric characters corresponding to a specific product or service item, such as “Captain Crunch™ Cereal”, “American Airlines Flight 697 from New York City to Chicago on Aug. 8, 2007”, or a category of product or service, such as “breakfast cereal”, “cleaning service”, or “food products”, or a brand of product or service. An optional graphical icon associated with the item identifier may include, for example, a graphical representation of a cereal box, optionally including a specific alphabetic or alphanumeric product code associated therewith. A vendor identifier may include alphabetic or alphanumeric characters corresponding to a specific vendor of a product or service, such as “Shop Rite™” or “American Airlines™”. An optional graphical icon associated with the vendor identifier may include, for example, a corporate logo or pictorial identifier for “Shop Rite™” or “American Airlines™”. An offered item price identifier is the price at which the specific vendor is offering the product or service for sale.

Input/output mechanism 137 is capable of generating a humanly discernible output in response to a signal received from processing mechanism 133, and is also capable of generating an electronic signal for receipt by processing mechanism 133 in response to a user input. The humanly discernible output may be generated in response to receipt of a matching price record. Input/output mechanism 137 can be implemented using a single integrated device, such as a touch-sensitive display screen, or using two or more separate devices such as a keyboard and a liquid crystal diode (LCD) display screen. Illustratively, input/output mechanism 137 includes one or more keys or buttons, a touch screen, a mouse, a stylus, or another device that converts mechanical energy into an electrical signal. Optionally, input/output mechanism 137 includes a printing mechanism or a printer data port to which an external printer may be connected.

Optionally, input/output mechanism 137 is capable of accepting a display command indicating that a user wishes to electronically display one or more stored matching price records on a display screen. In response to the display command, processing mechanism 133 retrieves display data corresponding to one or more stored matching price records from electronic memory 135, and provides the retrieved display data to a display controlling circuit, so as to cause a visual display on a display screen of input/output mechanism 137 of one or more matching price records stored in electronic memory 135.

According to exemplary embodiments, upon retrieving a matching price record from electronic memory 135, processing mechanism 133 processes the vendor identifier, item identifier, and offered item price identifier of the matching price record to electronically display vendor and price information on input/output mechanism 137, to print vendor and price information on a printer associated with customer endpoint device 101, or to print vendor and price information on a printer operatively coupled to input/output mechanism 137, or any of various combinations thereof Illustratively, this vendor and price information includes: (a) a vendor name, (b) the name of a product or service offered by the vendor, and (c) the price at which the vendor is offering the product or service. Optionally, this vendor and price information could be incorporated into a bar code or any other kind of identification information. Optionally, this information may include the expiration date for the price, or information regarding terms of a promotional offer associated with the product or service, or both. Pursuant to an optional feature, if a plurality of matching price records are stored in electronic memory 135, information from each of the plurality of matching price records may be displayed on input/output mechanism 137 in a sequential manner, one after another. Alternatively, two or more stored matching price records may be displayed simultaneously on input/output mechanism 137. Optionally, processing mechanism 133 is equipped with a timer, such that a matching price record will be deleted from memory after a price included in the price record has expired, or after expiration of a predetermined time interval, or both.

Illustrative examples for customer endpoint device 101 include a television set, a personal computer, a laptop computer, a personal digital assistant (PDA), a wireless telephone, an Ethernet-enabled device, a WiFi-enabled device, a media presentation device, a device equipped to receive internet protocol television (IPTV) programs, a microprocessor-based device, or the like.

Vendor endpoint device or system 103 represents any device that includes a processing mechanism 143 operatively coupled to an electronic memory 145, an input/output mechanism 147 operatively coupled to processing mechanism 143, and a communications mechanism 141 capable of initiating electronic communication over communications network 105. Processing mechanism 143 is capable of storing vendor information in electronic memory 145, and is also capable of retrieving vendor information from electronic memory 145. Input/output mechanism 147 is capable of generating a humanly discernible output in response to an electronic signal received from processing mechanism 143, and is also capable of generating an electronic signal for receipt by processing mechanism 143 in response to a user input. As previously described in connection with customer endpoint device 101, input/output mechanism 147 of vendor endpoint device or system 103 can be implemented using a single integrated device, such as a touch-sensitive display screen, or using two or more separate devices such as a keyboard and a liquid crystal diode (LCD) display screen. Illustrative examples for vendor endpoint device or system 103 include a mainframe computer, a television set, a personal computer, a laptop computer, a personal digital assistant (PDA), a network of computers, a wireless telephone, an Ethernet-enabled device, a WiFi-enabled device, a media presentation device, a microprocessor-based device, or the like. The specific architecture employed for vendor endpoint device or system 103 is illustrative in nature, it being clearly understood that other architectures could be employed instead of, or in addition to, the architecture shown in FIG. 1.

Price acquisition and notification server 107 maintains one or more databases that include customer preferences, vendor information, and prices acquired from vendor information in response to customer preferences. Accordingly, price acquisition and notification server 107 represents any system that includes a processing mechanism capable of storing vendor and price information on one or more databases, and capable of retrieving vendor and price information from one or more databases. As stated previously, these databases may include vendor information database 109, acquired prices database 111, and customer preferences database 113. Price acquisition and notification server 107 also includes a communications mechanism capable of initiating electronic communication over communications network 105. Illustrative examples for price acquisition and notification server 107 include a mainframe computer, a personal computer, a laptop computer, a network of computers, one or more PDAs, an Ethernet-enabled device, a WiFi-enabled device, a microprocessor-based device, a group of microprocessor-based devices, or the like.

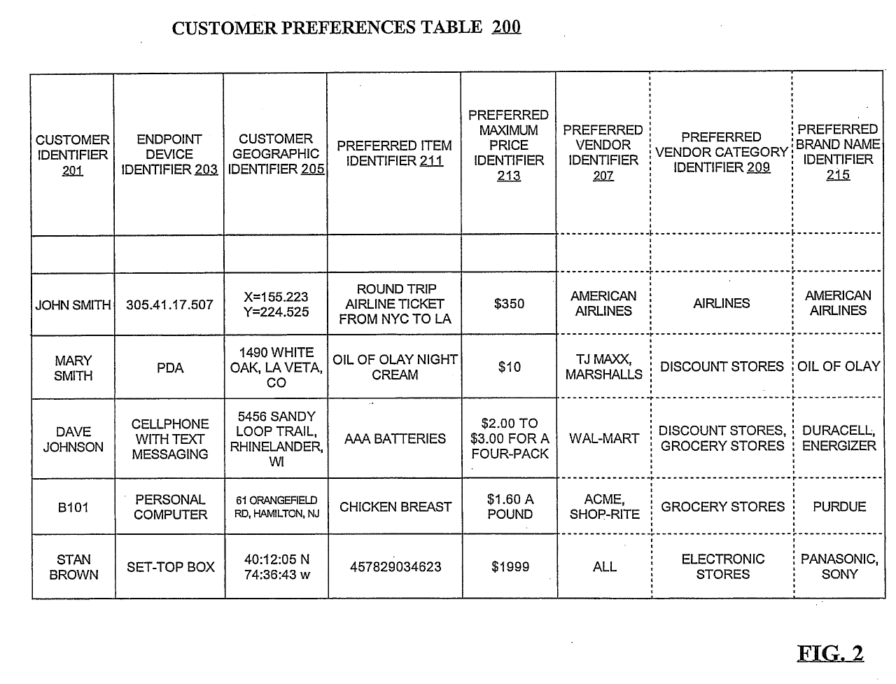

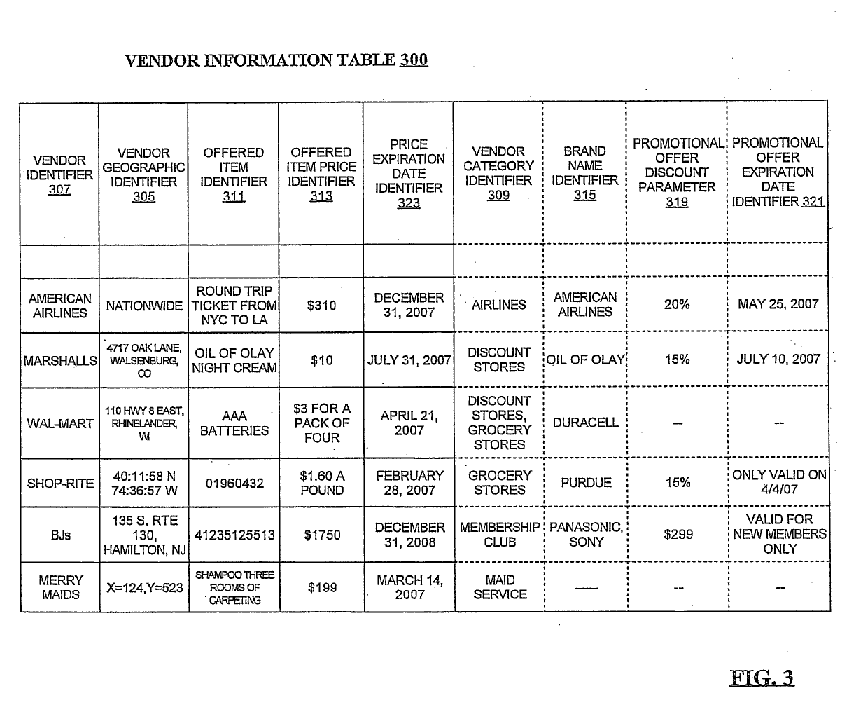

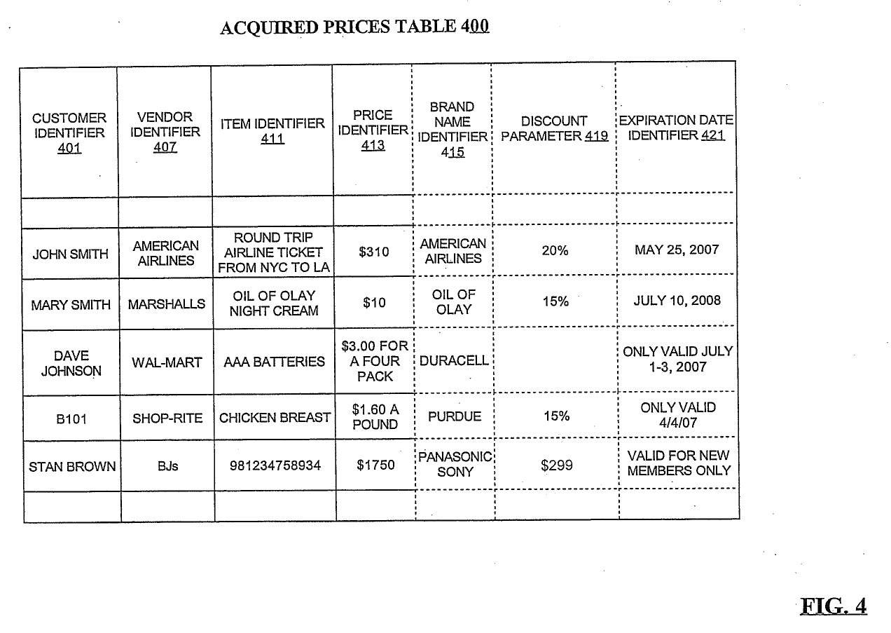

Customer preferences database 113 may, but need not, be organized in the form of a customer preferences table 200 as shown in FIG. 2. Likewise, vendor information database 109 may, but need not, be organized in the form of a vendor information table 300 as shown in FIG. 3, and acquired prices database 111 may, but need not, be organized in the form of an acquired prices table 400 as shown in FIG. 4. The data fields shown in FIGS. 2, 3, and 4 are illustrative in nature, as additional fields not shown may be utilized, or one or more of the depicted fields may be eliminated.

FIG. 2 is a data structure diagram showing an exemplary embodiment of the customer preferences table 200 for use with the system of FIG. 1. A customer identifier 201 is any numeric, alphanumeric, or alphabetic identifier that uniquely identifies a specific customer. In the example of FIG. 2, actual customer names such as John Smith are used as customer identifiers, and an example of an alphanumeric customer identifier is presented as “B101”. According to exemplary embodiments, customer identifier 201 is associated with at least one endpoint device identifier 203, a preferred item identifier 211, and a preferred maximum price identifier 213. Optionally, customer identifier 201 is also associated with a customer geographic identifier 205, a preferred vendor identifier 207, a preferred vendor category identifier 209, and a preferred brand name identifier 215.

Endpoint device identifier 203 specifies one or more characteristics of a customer endpoint device 101 (FIG. 1) used by a customer, such as the type or category of the endpoint device (i.e., personal computer versus wireless telephone), the media display capabilities of the device (i.e., audio only, still video, or full motion video), an internet protocol (IP) or global unique identifier (GUID) address used by the customer, or any of various combinations of the foregoing information. For example, if the customer uses a personal computer operatively coupled to a high-speed Internet connection, then endpoint device identifier 203 may include an IP address corresponding to the Internet connection, or an identifier indicative of the fact that customer endpoint device 101 is in the category of a personal computer.

Preferred item identifier 211 is any numeric, alphanumeric, or alphabetic identifier that identifies a product, a service, a product category, a service category, or any of various combinations thereof Optionally, preferred item identifier 211 includes supplemental information about a good or a service, such as the time at which the good or service is desired. For example, preferred item identifier 211 may specify a round trip airline ticket from New York City to Los Angeles any time during the month of July 2007.

Preferred maximum price identifier 213 is any numeric, alphanumeric, or alphabetic identifier that identifies the maximum price a customer is willing to pay for an item. Optionally, preferred maximum price identifier 213 could specify a range of prices a customer is willing to pay for an item, including a lower price limit and an upper price limit. In this manner, customers may seek out goods or services that are expected to have desired characteristics, features, or qualities corresponding to a specified price range without having to sort through numerous items in inappropriate price ranges.

Optional customer geographic identifier 205 includes geographic identifying indicia for a customer premises or a customer location. Geographic identifier 205 may include, for example, the street addresses and zip code for a customer premises, the latitude and longitude coordinates for the customer premises, X-Y coordinates for the customer premises, or any other variable which can be used to specify a location of a given customer premises.

Optional preferred vendor identifier 207 is any numeric, alphanumeric, or alphabetic identifier that identifies a specific vendor. In the example of FIG. 2, actual vendor names such as “American Airlines”, “TJ Maxx”, and “Shop-Rite” are used as vendor identifiers, although this is not required. Optional preferred vendor category identifier 209 is any numeric, alphanumeric, or alphabetic identifier that identifies one or more subject matter categories pertaining to preferred vendor identifier 207. These subject matter categories may, but need not, be defined in terms of vendor type, such as home repair stores, discount stores, grocery stores, and electronic stores, for example.

Optional preferred brand name identifier 215 is any numeric, alphanumeric, or alphabetic identifier that identifies one or more brand names offered by a vendor identified in a corresponding preferred vendor identifier 207 and related to subject matter set forth in a corresponding preferred item identifier 211. For example, a preferred brand name identifier 215 corresponding to a preferred vendor identifier 207 of “Wal-Mart” and a preferred item identifier 211 of “AAA Batteries” may include Duracell and Energizer. Optionally, the customer may specify a date or range of dates for which the customer plans to purchase a good or a service.

FIG. 3 is a data structure diagram showing an exemplary embodiment of the vendor information table 300 for use with the system of FIG. 1. A vendor identifier 307 is any numeric, alphanumeric, or alphabetic identifier that identifies a specific vendor. In the example of FIG. 3, actual vendor names such as “Marshalls”, “BJs”, and “Shop-Rite” are used as vendor identifiers, although this is not required. According to exemplary embodiments, vendor identifier 307 is associated with an offered item identifier 311, an offered item price identifier 313, a price expiration date identifier 323, an optional vendor geographic identifier 305, an optional vendor category identifier 309, an optional brand name identifier 315, an optional promotional offer discount parameter 319, and an optional promotional offer expiration date identifier 321.

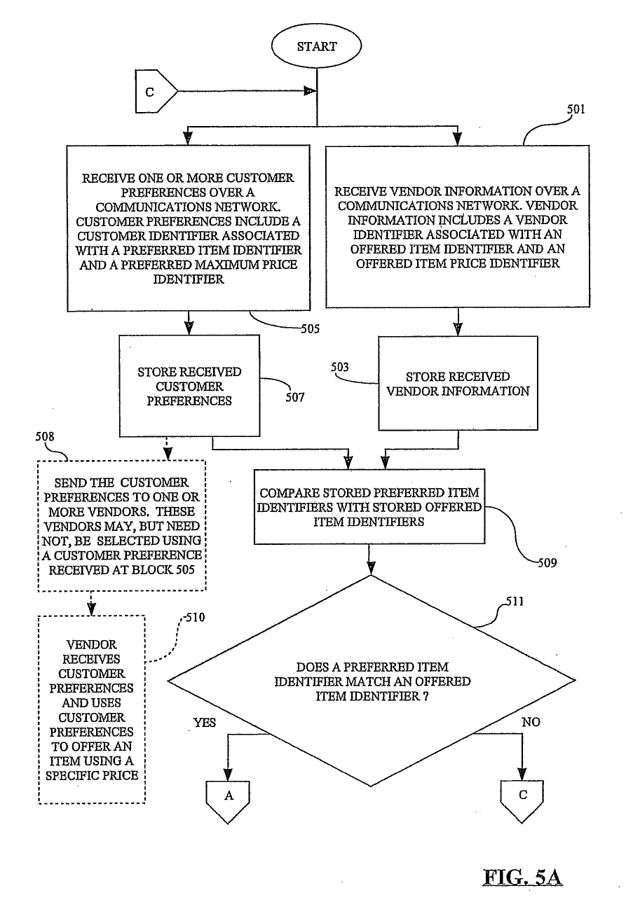

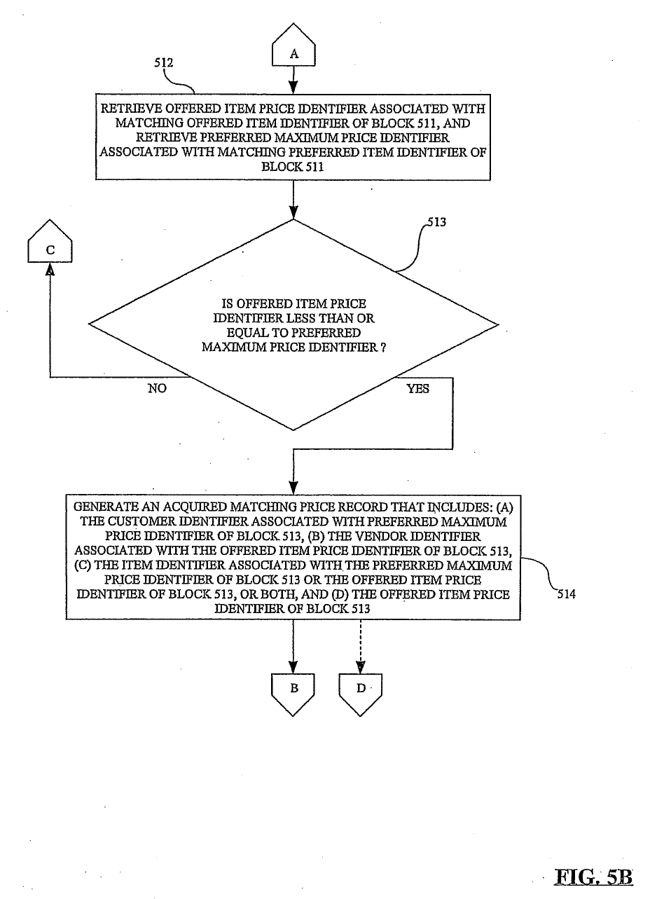

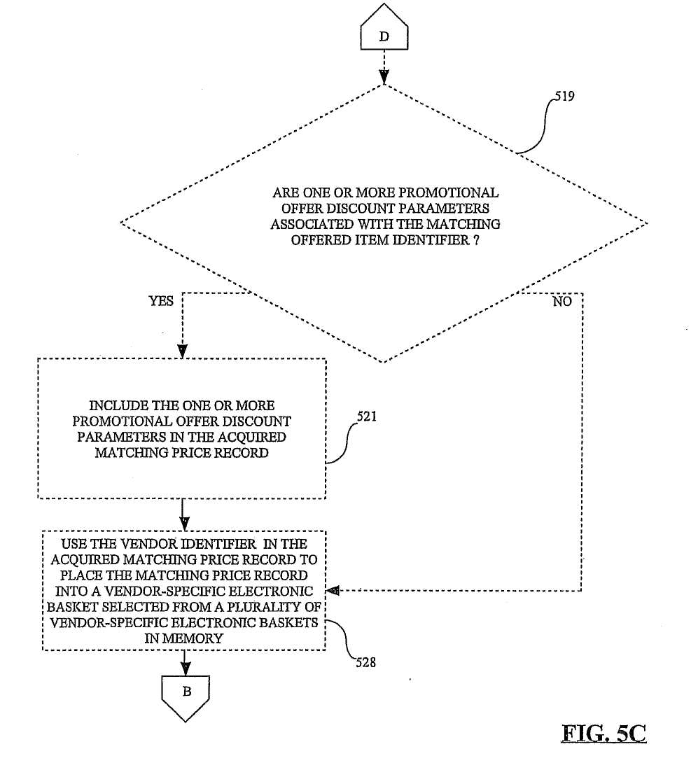

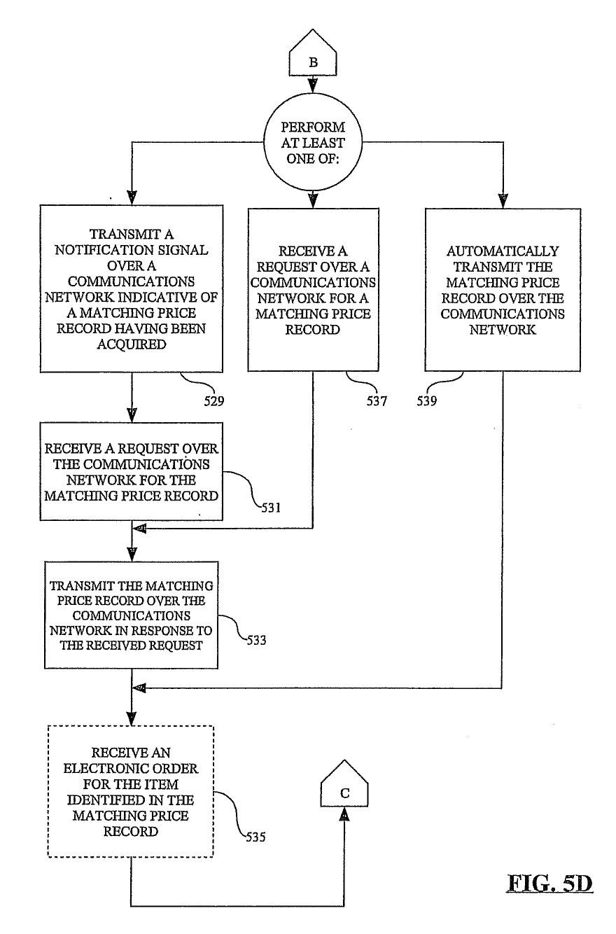

Offered item identifier 311 is any numeric, alphanumeric, or alphabetic identifier that identifies a product, a service, a product category, a service category, or any of various combinations thereof, offered by a vendor. Optionally, offered item identifier 311 includes supplemental information about a good or a service, such as the time at which the good or service is to be provided by the vendor. For example, offered item identifier 311 may specify a round trip airline ticket from New York City to Los Angeles departing at 3:11 PM on July 2007. In the case of a product, offered item identifier 311 could, but need not, be provided in the form of a product stock keeping unit (SKU) number. An SKU number is an alphanumeric or numeric identifier assigned to a particular product that enables the product to be tracked for inventory purposes. Typically, unique SKU identifiers are assigned to each of a plurality of purchasable items in a catalog, store, or posted on e-commerce websites. SKUs are usually defined and established by vendors. According to exemplary embodiments, offered item identifier 311 is compared with preferred item identifier 211 (FIG. 2) to generate acquired matching price records (FIG. 4), as will be described in greater detail hereinafter with reference to FIGS. 5A-5D.

Returning to FIG. 3, offered item price identifier 313 is any numeric, alphanumeric, or alphabetic identifier that specifies the price at which a vendor is offering to sell a good or a service. Optionally, offered item price identifier 313 could specify a range of prices for which a vendor is willing to sell an item (i.e., a good or a service), including a lower price limit and an upper price limit. In this manner, vendors are provided with the flexibility of selling an item at a higher price if a buyer has indicated a willingness to pay, while at the same time not losing sales to buyers who are only willing to pay a somewhat lesser price.

Price expiration date identifier 323 defines a date at which the price specified in a corresponding offered item price identifier 313 will expire. In this manner, vendors are provided with the flexibility to adjust prices in response to changing market conditions. Optionally, price expiration date identifier 323 may set forth a range of dates for which the price set forth in offered item price identifier 313 is valid. Moreover, the price set forth in offered item price identifier 313 could, but need not, represent a special promotional offer, whereupon the date set forth in price expiration date identifier 323 indicates the expiration date of the promotional offer. However, in circumstances where offered item price identifier 313 is intended to represent the regular, everyday price of an item, optional promotional offer discount parameter 319 and promotional offer expiration date identifier 321 may be employed, as will be discussed in greater detail hereinafter.

Optional vendor geographic identifier 305 includes geographic identifying indicia for a vendor location, set of vendor locations, or geographically defined area for which the vendor solicits or serves customers. Geographic identifier 305 may include, for example, the street addresses and zip code for a vendor location, the latitude and longitude coordinates for the vendor location, X-Y coordinates for the vendor location, a set of X-Y coordinates or latitudes and longitudes specifying a set of points which define an area, a geographic description of an area that specifies one or more states, counties, cities, or any other variable which can be used to specify a location for a given vendor. Optionally, vendor geographic identifier 305 is compared with customer geographic identifier 205 (FIG. 2) to generate acquired matching price records (FIG. 4, to be described hereinafter) only for vendors that solicit or serve customers in the geographic area specified by customer geographic identifier 205 (FIG. 2).

Optional vendor category identifier 309 is any numeric, alphanumeric, or alphabetic identifier that identifies one or more subject matter categories pertaining to vendor identifier 309. These subject matter categories may, but need not, be defined in terms of vendor type, such as home repair stores, discount stores, grocery stores, and electronic stores, for example. Optional brand name identifier 315 is any numeric, alphanumeric, or alphabetic identifier that identifies one or more brand names offered by a vendor identified in a corresponding vendor identifier 307 and related to subject matter set forth in a corresponding vendor offered item identifier 311. For example, a brand name identifier 315 corresponding to a vendor identifier 307 of “Wal-Mart” and a vendor offered item identifier 311 of “AAA Batteries” may specify a set of brand names carried by Wal-Mart, such as Duracell.

Optional promotional offer discount parameter 319 specifies at least one of a discount amount, a discount percentage, or a selling price for an item identified in a corresponding offered item identifier 311. Illustratively, discount parameter 319 may be expressed as a percentage discount (15%), a selling price ($299), or an amount to be subtracted from the selling price. Accordingly, discount parameter 319 is used to define the terms of a discount or incentive when this discount or incentive is to be offered to consumers. Promotional offer expiration date identifier 321 specifies at least one of an expiration date or a period of validity corresponding to promotional offer discount parameter 319.

FIG. 4 is a data structure diagram showing an exemplary embodiment of the acquired prices table 400 for use with the system of FIG. 1. In accordance with exemplary embodiments, for each of a plurality of matching price records, a customer identifier 401 is associated with a vendor identifier 407, an item identifier 411, a price identifier 413, an optional brand name identifier 415, an optional discount parameter 419, and an optional expiration date identifier 421. Customer identifier 401, copied or derived from customer identifier 201 of FIG. 2, is any numeric, alphanumeric, or alphabetic identifier that uniquely identifies a specific customer. Vendor identifier 407 (FIG. 4), copied or derived from vendor identifier 307 (FIG. 3), is any numeric, alphanumeric, or alphabetic identifier that identifies a specific vendor. Item identifier 411 (FIG. 4), copied or derived from offered item identifier 311 (FIG. 3), is any numeric, alphanumeric, or alphabetic identifier that identifies one or more categories of products or services offered by a vendor identified in a corresponding vendor identifier 407 (FIG. 4).

Optional brand name identifier 415, copied or derived from brand name identifier 315 (FIG. 3), is any numeric, alphanumeric, or alphabetic identifier that identifies one or more brand names offered by a vendor identified in a corresponding vendor identifier 407 (FIG. 4) and related to subject matter set forth in a corresponding item identifier 411. Optional discount parameter 419 and expiration date identifier 421 are defined as discussed above in connection with promotional offer discount parameter 319 and promotional offer expiration date identifier 321, respectively. Expiration date identifier 421 can be used to automatically remove or disable expired matching price records from acquired prices database 111 (FIG. 1), or to move expired matching price records from the acquired prices database to an archival database or data warehouse. Individual horizontal rows of acquired prices table 400 may each be conceptualized as comprising a matching price record.

FIGS. 5A-5D together comprise a flow diagram of an exemplary process for locating goods and services offered by vendors at customer preferred prices. At block 505 (FIG. 5A), one or more customer preferences are received over a communications network. These customer preferences include the customer identifier 201 (FIG. 2) associated with the preferred item identifier 211 and the preferred maximum price identifier 213. At block 501 (FIG. 5A), vendor information is received over a communications network. Vendor information includes the vendor identifier 307 (FIG. 3) associated with the offered item identifier 311 and the offered item price identifier 313. Blocks 501 and 505 (FIG. 5A) may be performed simultaneously, contemporaneously, or in any order.

Program control advances from block 505 to block 507 where received customer preferences are stored in a computer-readable storage medium. Illustratively, received customer preferences are stored in the form of the customer preferences table 200 (FIG. 2) discussed previously. Program control then advances to block 509 (FIG. 5A), to be described in greater detail hereinafter, and/or program control advances to optional block 508. At optional block 508, the customer preferences received at block 505 are sent to one or more vendors. These vendors may, but need not, be selected based upon customer preferences that were received at block 505, perhaps using the optional preferred vendor category identifier 209 (FIG. 2) or another received customer preference. The program then advances to optional block 510 (FIG. 5A), where the vendor receives the customer preferences and uses the customer preferences to offer an item using a specific price.

From block 501 (FIG. 5A), program control advances to block 503 where received vendor information is stored in a computer-readable storage medium. Illustratively, received vendor information is stored in the form of the vendor information table 300 (FIG. 3) discussed previously. Note that blocks 501 and 503 (FIG. 5A) may be executed one or more times for each of a plurality of vendors, and that blocks 505 and 507 may be executed one or more times for each of a plurality of customer preferences.

From block 503 or block 507, program control advances to block 509 where stored preferred item identifiers 211 (FIG. 2) are compared with stored offered item identifiers 311 (FIG. 3). Block 509 (FIG. 5A) may be performed once, repeatedly, at periodic or prescheduled intervals, in response to a receipt of new vendor information at block 501, in response to a receipt of new customer preferences at block 505, or in accordance with various combinations of the aforementioned performance times. Next, at block 511, a test is performed to ascertain whether or not any preferred item identifier matches an offered item identifier retrieved from the stored vendor information. If not, the program loops back to blocks 501 and 503.

The affirmative branch from block 511 leads to block 512 (FIG. 5B) where an offered item price identifier associated with the matching offered item identifier of block 511 (FIG. 5A) is retrieved. Also at block 512 (FIG. 5B), the preferred maximum price identifier associated with the matching preferred item identifier of block 511 (FIG. 5A) is retrieved. At block 513 (FIG. 5B), a test is performed to ascertain whether or not the offered item price identifier is less than or equal to the preferred maximum price identifier. If not, the program loops back to blocks 501 and 505 (FIG. 5A). Optionally, before the program loops back to blocks 501 and 505, although the offered item price identifier is not less than or equal to the preferred maximum price identifier, one or more of the price records matched to the item identifier are sent to the customer.

The affirmative branch from block 513 (FIG. 5B) leads to block 514 where an acquired matching price record is generated. The acquired matching price record includes: (a) the customer identifier associated with the preferred maximum price identifier of block 513, (b) the vendor identifier associated with the offered item price identifier of block 513, (c) the item identifier associated with the preferred maximum price identifier of block 513 and the offered item price identifier of block 513, and (d) the offered item price identifier of block 513. The program then advances to optional block 519 (FIG. 5C), or continues to any of blocks 529, 537, or 539 (FIG. 5D).

At optional block 519 (FIG. 5C), a test is performed to ascertain whether or not there are one or more promotional offer discount parameters 319 (FIG. 3) associated with the matching offered item identifier of block 513 (FIG. 5B). If so, the one or more promotional offer discount parameters are included in the acquired matching price record (optional block 521, FIG. 5C), and the program progresses to optional block 528. The negative branch from block 519 also leads to block 528. At block 528, the vendor identifier in the acquired matching price record is used to place the matching price record into a vendor-specific electronic basket selected from a plurality of vendor-specific electronic baskets in memory. The program then advances to any of blocks 529, 537, or 539 (FIG. 5D).

After block 514 (FIG. 5B) or optional block 528 (FIG. 5C) has been performed, the program then progress to at least one of blocks 529, 537, or 539 (FIG. 5D). Selection of block 529, 537, or 539 is an implementational detail that may be performed in accordance with the requirements or objectives of specific real-world applications. If more than one of blocks 529, 537 and 539 are performed, the blocks may be performed simultaneously, contemporaneously, repeatedly, in any order, or in any of various combinations thereof At block 529, a notification signal is transmitted over communications network 105 (FIG. 1) indicative of a matching price record having been acquired. This notification signal may be transmitted, for example, to a customer endpoint device 101 (FIG. 1) associated with a retrieved customer identifier 201, 401 (FIGS. 2 and 4). Illustratively, this customer endpoint device 101 (FIG. 1) is specified in the form of endpoint device identifier 203 (FIG. 2) of customer preferences table 200. The program progresses to block 531 (FIG. 5D) where a request is received over the communications network for the matching price record. This request may be received in the form of an inquiry signal issued by customer endpoint device 101 (FIG. 1). Program control then proceeds to block 533 (FIG. 5D), to be described in greater detail hereinafter.

At block 537, a request is received over the communications network for the matching price record. This request may be received in the form of an inquiry signal issued by customer endpoint device 101 (FIG. 1). The program then advances to block 533 (FIG. 5D), to be described hereinafter. At block 539, the matching price record is automatically transmitted over the communications network. This transmission may be received at customer endpoint device 101 (FIG. 1). Optionally, at block 535 (FIG. 5D), an electronic order is received for the item identified by item identifier 411 (FIG. 4) in the matching price record. The program then loops back to any of blocks 501 and 505 (FIG. 5A). Block 533 (FIG. 5D) is performed after execution of block 531 or block 537. At block 533, the matching price record is transmitted over the communications network in response to the received request. The program then advances to optional block 535 (discussed previously).

As described heretofore, the exemplary embodiments can be provided in the form of computer-implemented processes and apparatuses for practicing those processes. The exemplary embodiments can also be provided in the form of computer program code containing instructions embodied in tangible media, such as floppy diskettes, CD ROMs, hard drives, or any other computer-readable storage medium, wherein, when the computer program code is loaded into and executed by a computer, the computer becomes an apparatus for practicing the exemplary embodiments. The exemplary embodiments can also be provided in the form of computer program code, for example, whether stored in a storage medium, loaded into and/or executed by a computer, or transmitted over some transmission medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the exemplary embodiments. When implemented on a general-purpose microprocessor, the computer program code segments execute specific microprocessor machine instructions. The computer program code could be implemented using electronic logic circuits or a microchip.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed for carrying out this invention, but that the invention will include all embodiments falling within the scope of the claims. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

What is claimed is:

1. A method of locating items offered by vendors at customer preferred prices, the method comprising:
receiving customer preferences including a customer identifier associated with a preferred item identifier and a preferred maximum price identifier;
receiving vendor information including a vendor identifier associated with an offered item identifier and an offered item price identifier;
storing the customer preferences and vendor information, wherein the stored customer preferences include one or more stored preferred item identifiers and the stored vendor information includes one or more stored offered item identifiers;
comparing the stored preferred item identifiers with the stored offered item identifiers;
if a preferred item identifier matches an offered item identifier, then retrieving the offered item price identifier associated with the matching offered item identifier and retrieving the preferred maximum price identifier associated with the matching preferred item identifier; and
if the offered item price identifier is less than or equal to the preferred maximum price identifier, generating a matching price record.

2. The method of claim 1 wherein the matching price record includes at least two of: (a) the customer identifier that is associated with the preferred maximum price identifier, (b) the vendor identifier that is associated with the offered item price identifier, (c) the item identifier that is associated with the preferred maximum price identifier or the offered item price identifier, or (d) the offered item price identifier.

3. The method of claim 1 wherein the items include any of a product, a service, or a combination of products and services.

4. The method of claim 1 further including storing the received vendor information and the received customer preferences in a computer-readable storage medium.

5. The method of claim 1 further including sending the received customer preferences to one or more vendors based upon receiving from a customer at least one of: (a) a preferred vendor identifier, (b) a preferred vendor category identifier, (c) a preferred item identifier, or (d) a preferred brand name identifier.

6. The method of claim 5 further including the one or more vendors offering a product or a service based upon the preferred maximum price identifier.

7. The method of claim 1 further including transmitting the generated matching price record to at least one vendor based upon at least one of (a) a preferred vendor identifier, (b) a preferred vendor category identifier, (c) a preferred item identifier, or (d) a preferred brand name identifier.

8. The method of claim 1 further including transmitting the generated matching price record to a customer specified by a corresponding customer identifier from a respective received customer preferences.

9. A computer program product comprising a storage medium readable by a processing circuit and storing instructions for execution by the processing circuit for facilitating a method of locating items offered by vendors at customer preferred prices, the method comprising:
receiving customer preferences including a customer identifier associated with a preferred item identifier and a preferred maximum price identifier;
receiving vendor information including a vendor identifier associated with an offered item identifier and an offered item price identifier;
storing the customer preferences and vendor information, wherein the stored customer preferences include one or more stored preferred item identifiers and the stored vendor information includes one or more stored offered item identifiers;
comparing the stored preferred item identifiers with the stored offered item identifiers;
if a preferred item identifier matches an offered item identifier, then retrieving the offered item price identifier associated with the matching offered item identifier and retrieving the preferred maximum price identifier associated with the matching preferred item identifier; and
if the offered item price identifier is less than or equal to the preferred maximum price identifier, generating a matching price record.

10. The computer program product of claim 9 including instructions for generating a matching price record that includes at least two of: (a) the customer identifier that is associated with the preferred maximum price identifier, (b) the vendor identifier that is associated with the offered item price identifier, (c) the item identifier that is associated with the preferred maximum price identifier or the offered item price identifier, or (d) the offered item price identifier.

11. The computer program product of claim 9 wherein the items include any of a product, a service, or a combination of products and services.

12. The computer program product of claim 9 further including instructions for storing the received vendor information and the received customer preferences in a computer-readable storage medium.

13. The computer program product of claim 9 further including instructions for sending the received customer preferences to one or more vendors based upon receiving from a customer at least one of: (a) a preferred vendor identifier, (b) a preferred vendor category identifier, (c) a preferred item identifier, or (d) a preferred brand name identifier.

14. The computer program product of claim 9 further including instructions for transmitting the generated matching price record to at least one vendor based upon at least one of (a) a preferred vendor identifier, (b) a preferred vendor category identifier, (c) a preferred item identifier, or (d) a preferred brand name identifier.

15. The computer program product of claim 9 further including instructions for transmitting the generated matching price record to a customer specified by a corresponding customer identifier from respective received customer preferences.

16. A device or a group of devices for locating items offered by vendors at customer preferred prices, the device including:
an input mechanism for specifying customer preferences including a customer identifier, a preferred item identifier, and a preferred maximum price identifier;
a communications mechanism, operatively coupled to the input mechanism, for transmitting the specified customer preferences to a communications network, and for receiving a matching price record from the communications network, the matching price record including a vendor identifier associated with an offered item price identifier, the vendor identifier corresponding to a vendor offering the item for sale at an offered item price at or below a maximum price specified by the preferred maximum price identifier.

17. The device or group of devices of claim 16 further including an output mechanism, operatively coupled to the communications mechanism, for performing at least one of: (a) storing the matching price record in a computer-readable storage medium, (b) electronically displaying information indicative of the vendor identifier and the offered item price identifier, (c) outputting the matching price record to a data communications port, or (d) generating a printout indicative of the vendor identifier and the offered item price identifier.

18. The device or group of devices of claim 16 wherein the items include any of goods, services, or a combination of goods and services.

19. A system for locating items offered by vendors at customer preferred prices, the system including:
a receiving mechanism for receiving customer preferences and vendor information, the customer preferences including a customer identifier associated with a preferred item identifier and a preferred maximum price identifier, the vendor information including a vendor identifier associated with an offered item identifier and an offered item price identifier;
a computer readable storage mechanism for storing the customer preferences and vendor information, the stored customer preferences including one or more stored preferred item identifiers and the stored vendor information including one or more stored offered item identifiers;
a processing mechanism capable of comparing the stored customer preferences with the stored vendor information to determine whether or not a preferred item identifier matches an offered item identifier such that, if a match exists, the processing mechanism determines whether or not the offered item price identifier is less than or equal to the preferred maximum price identifier and, if so, the processing mechanism generates an acquired matching price record.

20. The system of claim 19 wherein the acquired matching price record includes at least two of. (a) the customer identifier that is associated with the preferred maximum price identifier, (b) the vendor identifier that is associated with the offered item price identifier, (c) the item identifier that is associated with the preferred maximum price identifier or the offered item price identifier, or (d) the offered item price identifier.
